(19) United States
(12) Patent Application Publication
(10) Pub. No.: US 2005/0052816 A1
(43) Pub. Date: Mar. 10, 2005

(54) Anion uninterruptible power supply (UPS)

(76) Inventors: Herlin Chang, Taipei (TW); Min-Huang Huang, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,982

(22) Filed: Sep. 4, 2003

(51) Int. Cl. H02H 1/00

(52) U.S. Cl. 361/225

(57) ABSTRACT

An UPS apparatus of the invention essentially comprises an AC detecting circuit, a charging circuit, a DC-AC converter circuit, an UPS output circuit, a control circuit and a power plug, wherein the UPS apparatus is installed with an anion producing circuit therein and the external housing of the UPS apparatus is installed with a release aperture to collocate with the anion producing circuit; when the UPS apparatus conducts electricity, the anion producing circuit would be started to proceed the work of producing the anions, and the anions would be dispersed to the external environment to purify the air, to reduce the occurrences of disease and to promote human's health.

### BACKGROUND OF THE INVENTION

1. Field of the invention

The invention relates to an anion Uninterruptible Power Supply (UPS) apparatus combined with an anion producing apparatus, and in particular, to an anion UPS apparatus installed an anion producing circuit in an UPS apparatus for continuously producing the anions upon conducting said UPS apparatus, to raise purification effect for the environment.

2. Description of the Prior Art

Due to rapid industry development, human invents many products to improve daily life, to rapidly raise material life standard and make human's life more comfortable. However, the inevitable problem accompanying with more convenience life is the pollution degree of the environment substantially rising, to seriously threat human's health and live.

Just as well, international environmental protection sense has risen accompanying with the cultural advancement, and many regulations have been established to limit pollution and preserve earth ecology permanently.

The present familiar pollution problems, except familiar trash pollution, most come from the invisible ion groups. People usually ignore the ions according to their invisible; however, various medical institutes have obviously proved the danger to human's health causing by the ions.

To solve the pollution problems mentioned above, applying the anions becomes an important subject in the present society. The anions could combine with the harmful ions to produce harmless compounds, to purify the air and preserve human's body.

The most present anion producing apparatuses are large-sized air conditioners, which are enormous, and need huge power consumption to produce large anions and provide preferred effect of the air purification. However, such large-sized equipments need proper setting space and could not focus on working on some particular areas, such as electric equipment products; thus the large anions produced by said large-sized equipments would disappear without developing their effects; the resources would only be wasted without achieving expected effects.

That proves the prior structure still could be modified and not a perfect design. For this purpose the inventor positively meditates modifying and considers to install an anion producing apparatus in an UPS apparatus to develop the best purifying effects of the anions; after repeatedly studying and practicing, has finally completed an UPS apparatus with an anion producing apparatus of the invention.

### SUMMARY OF THE INVENTION

An object of the invention is to provide an anion UPS apparatus, wherein an anion producing circuit is installed inside an UPS apparatus, to timely disperse the anions for purifying the air nearby and to provide better purification effect to the areas producing large ions for developing the best effects of the anions' functions when said UPS apparatus conducts electricity.

Another object of the invention is to provide an anion UPS apparatus, which is easily to be carried and furnished, wherein said anion producing circuit could continuously disperse the anions through the storage power of the UPS apparatus, even under a power failure, to decrease occurrences of diseases and promote human's health.

The inventor has considered that in normal life the electric equipment products are the most reasons to produce the harmful ions, thus the ions must be eliminated timely to decrease the damages to human; finally the inventor has successfully developed an anion UPS apparatus, which could achieve the purposes mentioned above. The inventor installs an anion producing circuit in an UPS apparatus base on the popularization and necessity of the UPS apparatus; while the UPS apparatus conducts electricity, the anion producing circuit immediately starts to work, to eliminate the harmful ions around the UPS apparatus and the electric equipment products surrounding said UPS apparatus, to achieve the purification effect.

### BRIEF DESCRIPTION OF THE DRAWINGS

The drawings disclose an illustrative embodiment of the present invention, which serves to exemplify the various advantages and objects hereof, and are as follows:

FIG. 1 is a three-dimensional diagram of the present invention; and

FIG. 2 is a detailed diagram showing the anion producing circuit of the present invention.

[Main Part Representative Numbers]

| | |
|---|---|
| 1 UPS apparatus | 11 power plug |
| 12 anion release aperture | 18 power switch |
| 2 anion producing circuit | 21 start switch |
| D1˜D5 diode | C1˜C5 capacitor |
| a \grave{ } b contact | G anion producing unit |
| T transformer | |

### DETAILED DESCRIPTION OF PREFERRED EMBODIMENT

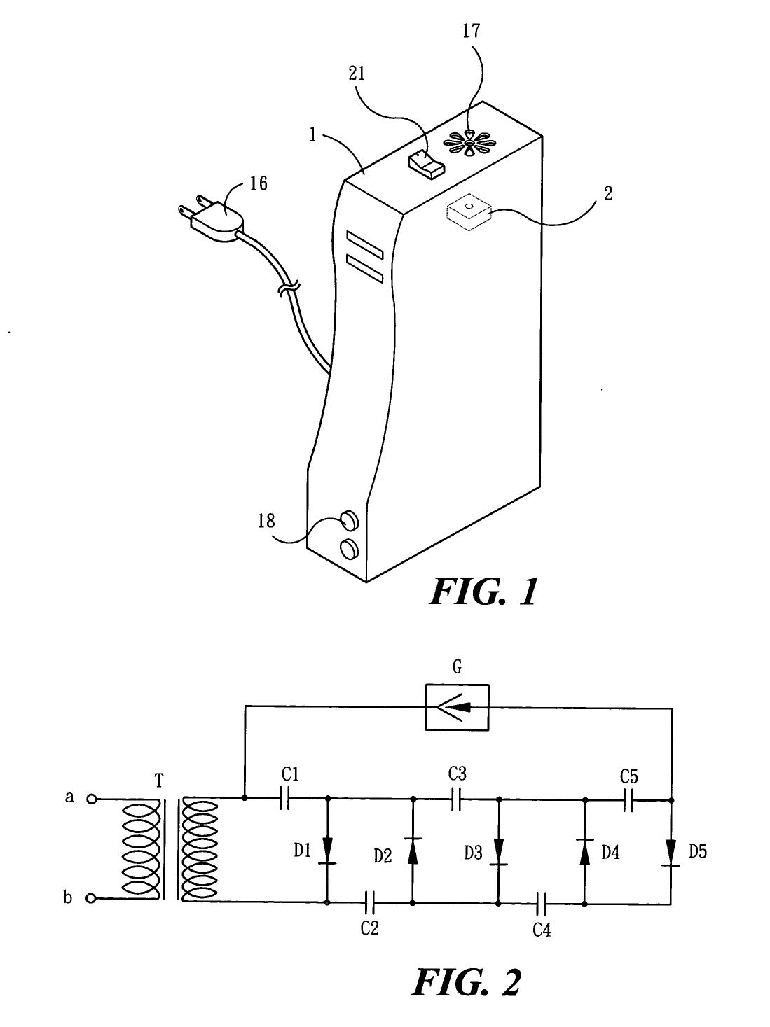

Referring to FIG. 1, the UPS apparatus 1 of the invention essentially comprises an AC detecting circuit, a charging circuit, a DC-AC converter circuit, an UPS output circuit, a control circuit and a power plug 11. Said power plug 11 is used to connect external power, the control circuit is used to control other apparatuses and said AC detecting circuit is used to detect whether AC power under normal condition to decide to proceed charging function to the UPS apparatus 1 by the charging circuit; when the AC detecting circuit detects AC power breaking down, the storage power would be transferred by the DC-AC converter circuit and be send out through the UPS output circuit. Each apparatus described above is the prior art structure of UPS apparatus 1.

Referring FIG. 2, an anion producing circuit 2 of the invention is essentially installed inside the rest space of the UPS apparatus 1, said anion producing circuit 2 has the contacts a, b to connect an anode-and-cathode conducting wire of the power source, and the power source would extend through a transformer T to change voltage, then passes the circuit composed by the diode D1˜D5 and the capacitor C1˜C5, and provides an anion producing unit G to produce the anions, to achieve the function of releasing the anions. The external housing of the UPS apparatus 1 is installed with a release aperture 12 to collocate with the anion producing circuit 2; when said UPS apparatus 1 conducts electricity to work, the anion producing circuit 2 has been started to proceed the work of producing the anions, and the anions would be dispersed to the environment through the release aperture 12, to reduce the occurrences of diseases and to promote human's health.

Furthermore, the anion producing circuit 2 is started synchronously through the power switch 18 of the UPS apparatus 1, when the UPS apparatus 1 is started, said anion producing circuit 2 immediately proceeds the work of air purification; however, said anion producing circuit 2 could also be provided by itself with the start switch 21, accordingly, when the UPS apparatus proceeds the work, said anion producing circuit 2 could decide whether proceeding the work by itself to achieve more elastic use function.

Moreover, due to the function of storage power of the UPS apparatus itself, even the external power breaks down, said anion producing circuit still could continuously disperse the anions to proceed the work of purification, and to make the anion producing circuit 2 fully develop the use function.

The invention provides an anion UPS apparatus, wherein the anion producing circuit has been installed inside the UPS apparatus, thus the anions could be dispersed timely to purify the air nearby while said UPS apparatus conducts electricity, to provide best purification effect for the areas producing large ions, and to develop the best effects of the anions' functions. And said anion UPS apparatus 1 has the function easily to be carried and furnished randomly, could disperse the anions appropriately according to users' requirements.

The detailed illustration is a specific statement according to one practicable embodiment of the invention, however the above descriptions of embodiments of the invention are not intended to be exhaustive or to limit the invention to the precise forms disclosed. Thus various equivalent modifications or corrections should include within the scope of the invention, as those skilled in the relevant art will recognize.

Many changes and modifications in the above described embodiment of the invention can, of course, be carried out without departing from the scope thereof. Accordingly, to promote the progress in science and useful arts, the invention is disclosed and is intended to be limited only by the scope of the appended claims.

1. An anion UPS apparatus, which characterizes in that:
an UPS apparatus of said anion UPS apparatus is installed with an anion producing circuit therein and could provide the electricity to make said anion producing circuit continuously disperse the anions.

2. An anion UPS apparatus according to claim 1, wherein said UPS apparatus is installed with a release aperture thereon to release the anions produced by said anion producing circuit.

3. An anion UPS apparatus according to claim 1, wherein said anion producing circuit could be started or closed individually, or be controlled by a control switch of said UPS apparatus.
